(19) United States
(12) Patent Application Publication
(10) Pub. No.: US 2006/0245512 A1
(43) Pub. Date: Nov. 2, 2006

(54) Apparatus and method for preventing call failure in an adaptive smart antenna system

(75) Inventors: Seok-Wan Rha, Seoul (KR); Young-Hoon Kwon, Sungnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/304,462

(22) Filed: Dec. 15, 2005

(30) Foreign Application Priority Data
Dec. 15, 2004 (KR) 0106133/2004

(51) Int. Cl. H04L 1/02

(52) U.S. Cl. 375/267

(57) ABSTRACT

A transmitter and transmission method for preventing a call failure using a system power value, caused by rapidly increasing transmit power against a large phase mismatch occurring before a phase mismatch correction cycle elapses in a smart-antenna communication system. In the transmitter and transmission method, if the system power value is higher than a power threshold, a radiation pattern similar to a common beam channel pattern is created.

### PRIORITY

This application claims priority under 35 U.S.C. § 119 to an application entitled “Apparatus And Method For Preventing Call Failure In An Adaptive Smart Antenna System” filed in the Korean Intellectual Property Office on Dec. 15, 2004 and assigned Serial No. 2004-106133, the contents of which are incorporated herein by reference.

### BACKGROUND OF THE INVENTION

1. Field of the Invention

The present invention relates generally to a transmitter and transmission method for preventing a call failure for a Mobile Station (MS) using a power value, caused by increasing transmit power for the MS against a large phase mismatch occurring before a phase mismatch correction cycle elapses above an allowed transmit power in a smart-antenna communication system. In particular, the present invention relates to a transmitter and transmission method for forming a radiation pattern similar to a common beam (overhead) channel pattern if a system power level exceeds a power threshold in a smart-antenna communication system.

2. Description of the Related Art

A smart antenna system is a communication system that automatically optimizes a radiation pattern adaptively according to a signal environment by use of a plurality of antennas. As the smart antenna system transmits a signal in an intended direction for an MS through beamforming, it saves power in signal transmission and reduces interference, compared to omni-directional signal transmission to all MSs. Within the coverage area of the same Base Station (BS), the smart antenna system actively locates a particular MS and concentrates transmit power in the direction of the MS, thereby minimizing interference to other MSs located in other directions. In this context, such a smart antenna system with a plurality of antennas is physically mounted to the BS and designed so as to radiate a signal only in a desired direction for a particular MS and thus minimize interference to other MSs. Thus, the BS provides a service of the same quality with less power than a conventional BS and allocates the saved power to service other MSs. Consequently, each BS can service more MSs.

However, the smart-antenna communication system suffers phase mismatch. FIG. 1 illustrates a radio environment which causes phase mismatch to the smart-antenna communication system.

Referring to FIG. 1, there are scatterers such as buildings around a BS and an MS receives signals reflected from the scatterers. A wide beam carrying a common pilot signal is spread to all MSs within the coverage radius of the BS in a common beam channel pattern. With the wide beam, the MS receives signals from each of paths (1), (2), (3) and (4) created by the scatterers. By contrast, a traffic channel carrying a traffic signal dedicated to a particular MS is sent to the MS in a narrow beam having a directional radiation pattern. Hence, the MS receives traffic signals from the paths (1) and (2). The directional radiation pattern gets phase components over different paths from the common beam channel pattern while it travels through multiple paths inherent to the radio channel environment. This phase mismatch decreases the received Signal-to-Noise Ratio (SNR) of the MS.

FIG. 2 is a flowchart illustrating a phase mismatch correction operation in a conventional smart-antenna communication system. This operation is about correction of the above-described phase mismatch between radiation patterns.

Referring to FIG. 2, the BS receives a feedback Channel Quality Indicator (CQI) from the MS in step 210 and forms a radiation pattern according to the location of the MS in step 220. The BS then calculates the phase mismatch of the radiation pattern and compares the phase mismatch with a threshold (pm_threshold) in step 230. If the phase mismatch is less than or equal to the threshold, the BS forms a narrow beam pattern with strong directionality in step 240. If the phase mismatch exceeds the threshold, the BS forms a wide beam pattern similar to a common beam channel pattern in step 250. In this way, the BS selects a final radiation pattern in step 260 between the common beam channel pattern and the directional radiation pattern for the MS. The BS applies a final beamforming weight vector for the MS in step 270. If the phase mismatch between the common beam channel pattern and the directional channel pattern of the MS is kept at or above the threshold, the common beam channel pattern is used as the directional channel pattern for the MS.

A distinctive shortcoming with this conventional phase mismatch correction is that only a particular radio channel environment among many radio channel environments is considered in a phase mismatch calculation formula and thus the phase mismatch calculation formula itself has errors. In addition, there is an error caused by the difference between a power control time and a beamforming weight vector applying time. In the case where power control is performed every 1.25 ms and the beamforming weight vector is changed every about 80 ms, an error can be created due to a channel environment change during resetting the beamforming weight vector and the difference between a channel generation time and a beamforming weight vector applying time. Another problem arises from the difficulty of formulating the amount of power added to correct the phase mismatch, that is, the difficult quantification of the impact which the calculated phase mismatch imposes on actual system power control. Therefore, a quantification interpretation discrepancy exists between the phase mismatch and system power control based on the phase mismatch.

In case a significant channel change occurs in the course of applying the beamforming weight vector as illustrated in FIG. 3, the resulting beam does not reflect the channel change sufficiently. Moreover, the time when the beam is formed can be far away from the time when the channel change occurred. In a rapidly changing radio channel environment facing the above-described problems, the phase mismatch is beyond an acceptable level for the MS.

Particularly in a smart antenna system having a power control correction cycle shorter than a beamforming weight vector correction cycle, for example, in a smart antenna system where power control is carried out every 1.25 ms and a beamforming weight vector is changed every about 80 ms, if the phase mismatch becomes large in the middle of resetting the beamforming weight vector, the BS increases transmit power for the MS beyond an allowed power level for one MS, aside from phase mismatch correction to compensate for the decrease of a reception gain. Consequently, gain compensation is not effective through power control any more, and if the phase mismatch is kept uncorrected, the resulting high error rate leads to a call failure for the MS. In this case, power control with no regard to phase mismatch may cause power control imbalance and interference to other MSs, as well. This phenomenon is frequently observed in an urban area when the performance of a smart-antenna technology is simulated. Accordingly, a need exists for an apparatus and method for preventing a call failure for an MS caused by increasing transmit power in response to a significant phase mismatch occurring within a phase mismatch correction cycle, that is before next phase mismatch correction cycle does not begin, beyond an allowed power level per MS.

### SUMMARY OF THE INVENTION

An object of the present invention is to substantially solve at least the above problems and/or disadvantages and to provide at least the advantages described below. Accordingly, an object of the present invention is to provide an apparatus and method for preventing a call failure for an MS caused by a rapid increase in transmit power in response to a significant phase mismatch occurring within a phase mismatch correction cycle in a smart-antenna communication system.

Another object of the present invention is to provide an apparatus and method for preventing a call failure for an MS using a power control value, which is caused by a rapid increase in transmit power in response to a significant phase mismatch occurring within a phase mismatch correction cycle in a smart-antenna communication system.

The above objects are achieved by providing a transmitter and transmission method for preventing a call failure using a system power value, caused by rapidly increasing transmit power in response to a large phase mismatch occurring between a phase mismatch correction cycle in a smart-antenna communication system.

According to one aspect of the present invention, in a transmitter in a smart-antenna communication system, a channel card compares a power value determined according to a feedback CQI received from a receiver with a power threshold, forms a common beam channel pattern if the power value is greater than the power threshold, forms a directional channel pattern if the power value is less than or equal to the power threshold, and transmits a data signal in the formed channel pattern to the receiver through an antenna.

According to another aspect of the present invention, in a transmission method in a smart-antenna communication system, a power value is determined according to a feedback CQI received from a receiver and compared with a power threshold. If the power value is greater than the power threshold, a common beam channel pattern is selected. A beamforming weight vector is determined for the common beam channel pattern. A beam pattern is formed according to the beamforming weight vector and a data signal is transmitted in the formed channel pattern to the receiver through an antenna.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a radio channel environment causing a phase mismatch in a smart-antenna communication system;

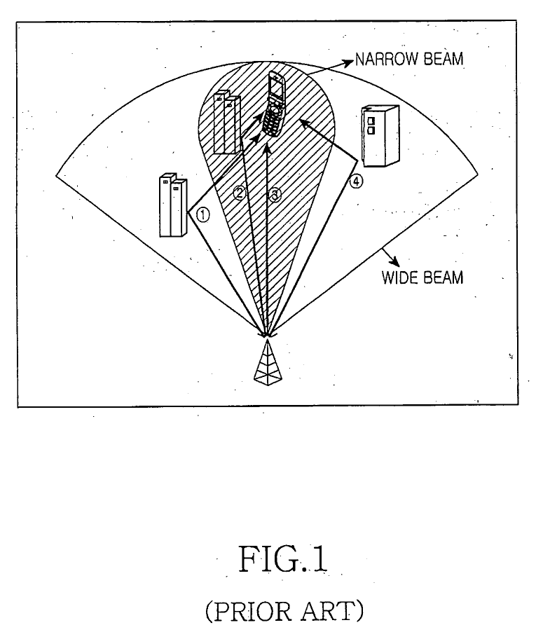

FIG. 2 is a flowchart illustrating a conventional phase mismatch correction operation in the smart-antenna communication system;

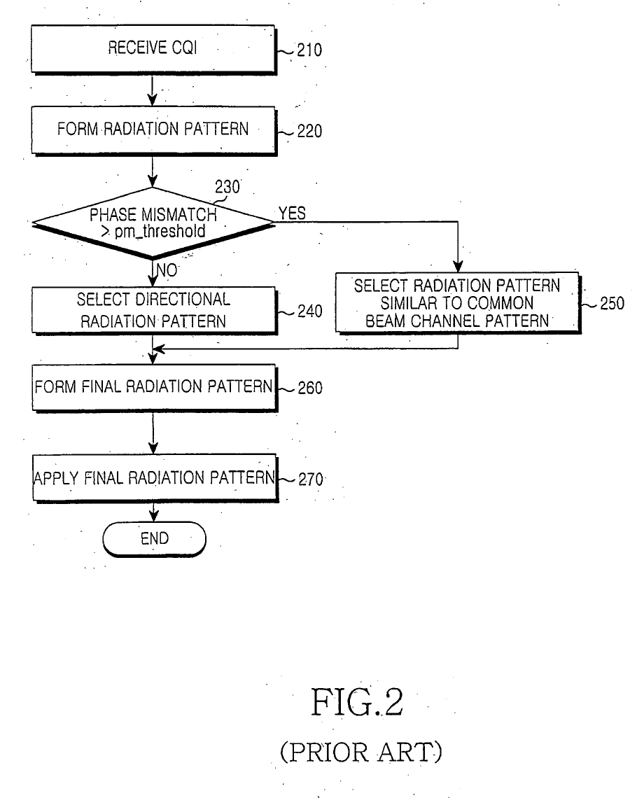

FIG. 3 illustrates a beamforming weight vector applying timing and a radio channel environment change in the smart-antenna communication system;

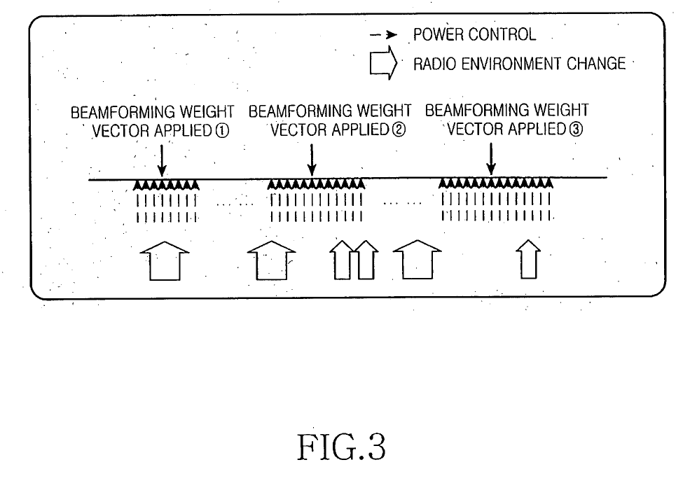

FIG. 4 is a flowchart illustrating a phase mismatch correction operation in a smart-antenna communication system according to the present invention;

FIG. 5 is a block diagram of a BS transmitter in the smart-antenna communication system according to the present invention; and

FIGS. 6A and 6B illustrate beam radiation patterns in the smart-antenna communication system according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention provides a transmitter and transmission method for preventing a call failure using a system power value, caused by rapidly increasing transmit power against a large phase mismatch occurring before a phase mismatch correction cycle elapses in a smart-antenna communication system. In the transmitter and transmission method, if the system power value is higher than a power threshold, a radiation pattern similar to a common beam channel pattern is created.

The following description is made in compliance with the cdma2000 Release C standard. A power value defined in this standard is utilized in forming a radiation pattern in a smart-antenna communication system. A power value available to a BS ranges from −40.0 to 0.0 dB and is controllable on a 0.25-dB basis. Although a power value that can be allocated to a traffic channel for one MS is between −40.0 and −7.0 dB, an MS power control range is set to be from −40.0 to −19.0 dB, considering a beamforming gain (+12 dB) in the smart antenna system. The system power is reset every 1.25 ms according to a power control algorithm defined in the cdma2000 Release C standard. Upon detection of a forward frame error, the BS increases the transmit power by 1.0 dB in 1.25 ms. In the absence of a forward frame error, the BS decreases the transmit power by 1/99 dB. This changed power value, i.e. Digital Gain Unit (DGU) is adjusted on a 0.25 dB by 0.25 dB basis. While the conventional smart-antenna system generates a beamforming weight vector using a calculated phase mismatch only, the present invention additionally uses the DGU in generating the beamforming weight vector.

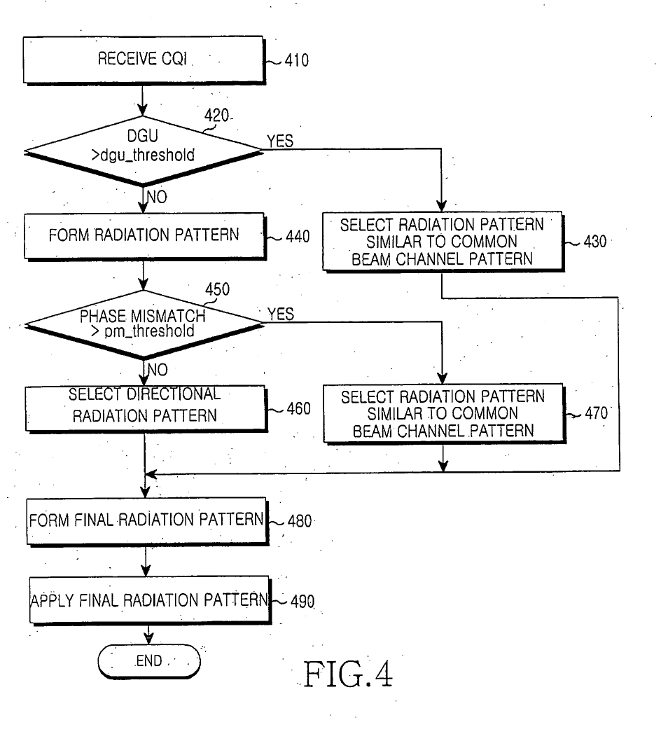

FIG. 4 is a flowchart illustrating a phase mismatch correction operation in a smart-antenna communication system according to the present invention.

Referring to FIG. 4, the BS receives the feedback CQI of a downlink signal from the MS in step 410 and compares a DGU set according to the CQI with a DGU threshold (dgu_threshold) in step 420. DGU values corresponding to CQIs are preset in the BS. The DGU of the BS is corrected every 1.25 ms. Thus, the DGU is compared with the DGU threshold at the same interval. The DGU threshold is a predetermined proportion of a maximum power value available to one MS, preferably 70 to 80%. The maximum power value available to one MS is known to the BS. If the DGU exceeds the DGU threshold, the BS selects a radiation pattern similar to a common beam channel pattern in step 430 and forms the final radiation pattern in step 480. In step 490, the BS forms a beam with a beamforming weight vector corresponding to the radiation pattern and transmits data with the beam to the MS. On the other hand, if the DGU is less than or equal to the DGU threshold, the BS forms a radiation pattern according to the location of the MS in step 440. The BS estimates the phase mismatch of the radiation pattern and compares the phase mismatch with a predetermined phase mismatch threshold (pm_threshold) in step 450. The phase mismatch can be obtained by measuring a Packet Error Rate (PER). If the phase mismatch estimate exceeds the phase mismatch threshold, the BS selects a radiation pattern similar to the common beam channel pattern in step 470 and forms the final radiation pattern in step 480. If the phase mismatch estimate is less than or equal to the phase mismatch threshold, the BS forms a directional radiation pattern in step 460. In step 490, the BS forms a beam with a beamforming weight vector corresponding to the directional radiation pattern and transmits data with the beam to the MS. The beamforming weight vector correction in conjunction with phase mismatch measuring is carried out every 80 ms.

Since a radiation pattern is formed by comparing a system DGU with a predetermined DGU threshold, that is, a common beam channel pattern is selected if the DGU exceeds the power threshold within an available DGU range, the increase of the system power above an allowed DGU limit due to a phase mismatch is prevented. However, this phase mismatch correction method cannot prevent a rapid increase in the DGU, caused by a phase mismatch occurring at or below a DGU threshold of −40 to −20.0 dB.

To overcome this problem, a radiation pattern can be formed using a DGU change rate threshold ranging from 5.0 to 10.0 dB. If a DGU change rate measurement is greater than or equal to the threshold, the common beam channel pattern is selected irrespective of the result of the algorithm, thereby preventing a phase mismatch-caused rapid power increase beforehand. This method, however, cannot prevent the power increase above the allowed power limit, even when the phase mismatch continuously occurs.

A combination of the above two phase mismatch correction methods can prevent a phase mismatch-caused rapid power increase and a power increase beyond an allowed power limit. This method also has a shortcoming that the gain of the smart antenna technology is reduced.

Therefore, the three phase mismatch correction methods for the smart antenna system can be selectively used according to circumstances.

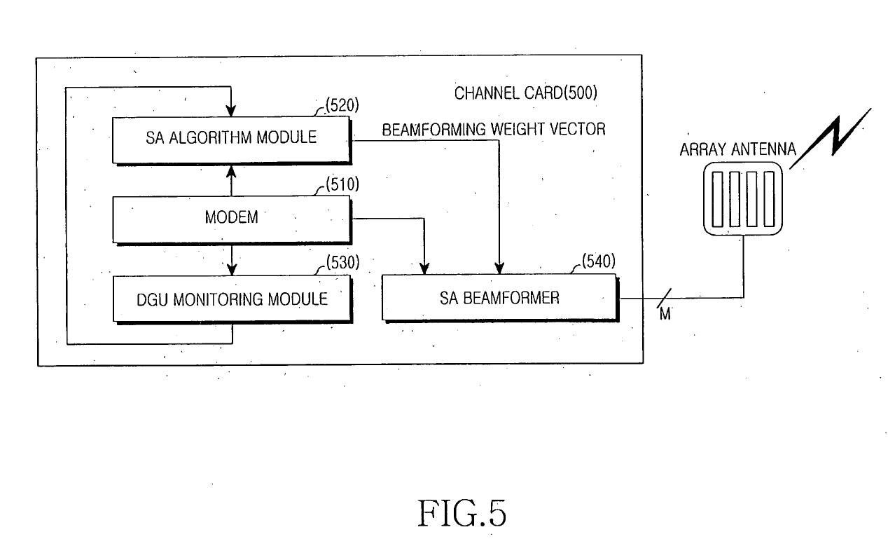

FIG. 5 is a block diagram of a BS transmitter in the form of a channel card 500 in the smart-antenna communication system according to the present invention.

Referring to FIG. 5, a MODEM 510 provides a feedback CQI from the MS to a Smart Antenna (SA) algorithm module 520, for beamforming on a data traffic channel. At the same time, the MODEM 510 provides a DGU determined by power control to a DGU monitoring module 530. The DGU monitoring module 530 determines a beam pattern and notifies the SA algorithm module 520 of the determined beam pattern. The SA algorithm module 520 transmits a beamforming weight vector to an SA beamformer 540.

That is, the MODEM 510 provides a feedback CQI received from the MS to the SA algorithm module 520, and provides a DGU determined according to the CQI to the DGU monitoring module 530. The DGU monitoring module 530 selects a common beam channel pattern if the DGU is greater than a DGU threshold, and selects a directional channel pattern if the DGU is less than or equal to the DGU threshold. The SA algorithm module 520 determines a beamforming weight vector depending on the common beam channel pattern or the direction channel pattern. The SA beamformer 540 forms a beam pattern corresponding to the beamforming weight vector and transmits a data signal in the beam pattern to a receiver at the MS.

If the DGU monitoring module 530 selects the direction channel pattern, the MODEM 510 further functions to measure the phase mismatch of the direction channel pattern and determines the common beam channel pattern as a final radiation pattern if the phase mismatch is larger than a phase mismatch threshold.

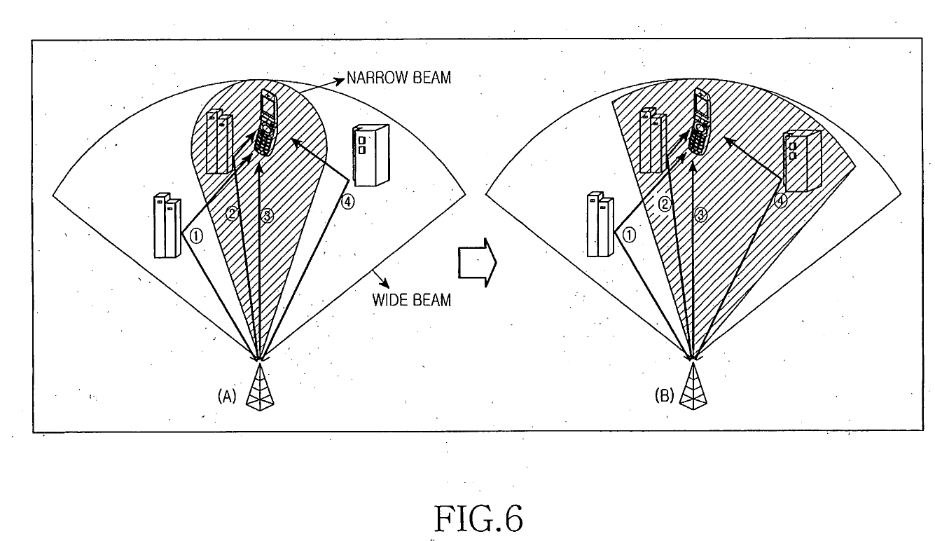

FIGS. 6A and 6B illustrate beam radiation patterns in the smart-antenna communication system according to the present invention. The radiation pattern of a traffic channel is changed according to the procedure illustrated in FIG. 4. First, a directional radiation pattern is formed in the direction of an MS, as illustrated in FIG. 6A. When an error occurs at the MS due to a phase mismatch caused by scatterers around a BS, the BS allocates more transmit power to the MS to overcome the phase mismatch. The change of the transmit power is monitored. If the power change fulfils the condition described in FIG. 4, the radiation pattern of the traffic channel is changed to be similar to the common beam channel pattern, as shown in FIG. 6B As described above, the present invention advantageously reduces phase mismatch-incurred loss, enables stable gain achievement, and prevents a phase mismatch-caused power increase beyond an allowed power limit. Therefore, a call failure which might otherwise occur is prevented.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmitter in a smart-antenna communication system, comprising:
a channel card for comparing a power value determined according to a feedback channel quality indicator (CQI) received from a receiver with a power threshold, forming a common beam channel pattern if the power value is greater than the power threshold, forming a directional channel pattern if the power value is less than or equal to the power threshold, and transmitting a data signal in the formed channel pattern to the receiver through an antenna.

2. The transmitter of claim 1, wherein the power threshold is 70 to 80% of a maximum power value available to the transmitter.

3. The transmitter of claim 1, wherein if the directional channel pattern is formed, the channel card measures the phase mismatch of the directional channel pattern and substitutes the common beam channel pattern for the directional channel pattern if the phase mismatch is larger than a phase mismatch threshold.

4. A transmitter in a smart-antenna communication system, comprising:
a channel card for comparing a power change rate determined according to a feedback channel quality indicator (CQI) received from a receiver with a power change rate threshold, forming a common beam channel pattern if the power change rate is greater than the power change rate threshold, forming a directional channel pattern if the power change rate is less than or equal to the power change rate threshold, and transmitting a data signal in the formed channel pattern to the receiver through an antenna.

5. A transmitter in a smart-antenna communication system, comprising:
a MODEM for providing a feedback channel quality indicator (CQI) received from a receiver to a smart antenna (SA) algorithm module and providing a power value determined according to the CQI to a power monitoring module;
the power monitoring module for selecting a common beam channel pattern if the power value is greater than a power threshold, and forming a directional channel pattern if the power value is less than or equal to the power threshold;
the SA algorithm module for determining a beamforming weight vector depending on whether the common beam channel pattern or the directional channel pattern is selected; and
an SA beamformer for forming a beam pattern according to the beamforming weight vector and transmitting a data signal in the beam pattern to the receiver through an antenna.

6. The transmitter of claim 5, wherein the power threshold is 70 to 80% of a maximum power value available to the transmitter.

7. The transmitter of claim 5, wherein if the power monitoring module selects the directional channel pattern, the MODEM measures the phase mismatch of the directional channel pattern and substitutes the common beam channel pattern for the directional channel pattern if the phase mismatch is larger than a phase mismatch threshold.

8. A transmitter in a smart-antenna communication system, comprising:
a MODEM for providing a feedback channel quality indicator (CQI) received from a receiver to a smart antenna (SA) algorithm module and providing a power change rate determined according to the CQI to a power monitoring module;
the power monitoring module for selecting a common beam channel pattern if the power change rate is greater than a power change rate threshold, and forming a directional channel pattern if the power change rate is less than or equal to the power change rate threshold;
the SA algorithm module for determining a beamforming weight vector depending on whether the common beam channel pattern or the directional channel pattern is selected; and
an SA beamformer for forming a beam pattern according to the beamforming weight vector and transmitting a data signal in the beam pattern to the receiver through an antenna.

9. The transmitter of claim 8, wherein if the power monitoring module selects the directional channel pattern, the MODEM measures the phase mismatch of the directional channel pattern and substitutes the common beam channel pattern for the directional channel pattern if the phase mismatch is larger than a phase mismatch threshold.

10. A transmission method in a smart-antenna communication system, comprising the steps of:
determining a power value according to a feedback channel quality indicator (CQI) received from a receiver;
comparing the power value with a power threshold;
selecting a common beam channel pattern if the power value is greater than the power threshold;
determining a beamforming weight vector for the common beam channel pattern; and
forming a beam pattern according to the beamforming weight vector and transmitting a data signal in the formed channel pattern to the receiver through an antenna.

11. The transmission method of claim 10, wherein the power threshold is 70 to 80% of a maximum power value available to a transmitter.

12. The transmission method of claim 10, further comprising, if the power value is less than or equal to the power threshold, selecting a directional channel pattern, measuring the phase mismatch of the directional channel pattern, and substituting the common beam channel pattern for the directional channel pattern if the phase mismatch is larger than a phase mismatch threshold.

13. A transmission method in a smart-antenna communication system, comprising the steps of:
determining a power change rate according to a feedback channel quality indicator (CQI) received from a receiver;
comparing the power value with a power change rate threshold;
selecting a common beam channel pattern if the power change rate is greater than the power change rate threshold;
determining a beamforming weight vector for the common beam channel pattern; and
forming a beam pattern according to the beamforming weight vector and transmitting a data signal in the formed channel pattern to the receiver through an antenna.

14. The transmission method of claim 13, further comprising, if the power change rate is less than or equal to the power change rate threshold, selecting a directional channel pattern, measuring the phase mismatch of the directional channel pattern, and substituting the common beam channel pattern for the directional channel pattern if the phase mismatch is larger than a phase mismatch threshold.
